(19) United States
(12) Patent Application Publication
(10) Pub. No.: US 2025/0382683 A1
(43) Pub. Date: Dec. 18, 2025

(54) Nickel-Based Alloy

(71) Applicant: Hitachi-GE Nuclear Energy, Ltd., Hitachi-shi, Ibaraki (JP)

(72) Inventors: Yun WANG, Tokyo (JP); Ryouji OBATA, Ibaraki (JP); Shinichi ISHIOKA, Ibaraki (JP)

(21) Appl. No.: 18/878,246

(22) PCT Filed: Apr. 26, 2023
(86) PCT No.: PCT/JP2023/016469

§ 371 Date: Dec. 23, 2024

(30) Foreign Application Priority Data
Jul. 7, 2022 (JP) 2022-110041

(51) Int. Cl. C22C 19/05; G21D 1/00

(52) U.S. Cl. CPC C22C 19/05; G21D 1/00

(57) ABSTRACT

An object of the invention is to provide a nickel-based alloy which hardly causes hardening and embrittlement due to thermal aging in a high-temperature environment and has excellent aging resistance. A nickel-based alloy contains Cr as an essential component, and optionally contains one or more of Fe, Nb, Mn, and Mo as an optional component, with the balance being Ni and unavoidable impurities. When [% Ni], [% Cr], [% Fe], [% Nb], [% Mn], and [% Mo] are atomic concentrations of respective elements, an atomic concentration ratio of Ni to Cr [% Ni]/[% Cr] is 1.8 or more and 2.2 or less, and [% Fe]+0.49 [% Nb]+0.63 [% Mn] +0.05 [% Mo]≥14 is satisfied.

### TECHNICAL FIELD

The present invention relates to a nickel-based alloy with excellent aging resistance against thermal aging.

### BACKGROUND ART

Nickel-based alloys are materials excellent in mechanical properties and corrosion resistance, and are widely used as materials for structural members and the like from general industrial use to nuclear power device applications. As a material for an in-reactor structure or an in-reactor device of a nuclear power plant, stainless steel or a Ni—Cr nickel-based alloy having excellent corrosion resistance is used.

It is known that, in a boiling water reactor (BWR), stress corrosion cracking (SCC) occurs in a material at a site that comes into contact with high-temperature and high-pressure react water. Chromium contained in the material reacts with carbon in a high-temperature and high-pressure environment to form a Cr carbide. It is known that when a chromium-deficient layer is formed by the formation of the Cr carbide, SCC is likely to occur when a stress is applied.

PTL 1 describes a nickel-based alloy welding material that has good SCC resistance and excellent weldability. This material contains, by mass %, Cr:more than 30.0% and 36.0% or less, C: 0.050% or less, Fe: 1.00% or more and 3.00% or less, Si: 0.50% or less, Nb+Ta: 3.00% or less, Ti: 0.70% or less, Mn: 0.10% or more and 3.50% or less, and Cu: 0.5% or less, with the balance being Ni and unavoidable impurities.

PTL 2 describes a method for producing a high-Cr and high-Ni alloy tube which does not cause a decrease in an impact value at 20° C. in a Charpy impact test during production and has good toughness. This material contains, by mass %, C: 0.05% to 0.09%, Si: 0.05% to 0.4%, Mn: 0.05% to 1.3%, P: 0.015% or less, S: 0.005% or less, Ni: 44% to 52%, Cr: 22% to 32%, Ti: 0.05% to 1.0%, sol.Al: 0.005% to 0.2%, and one or two of B: 0.001% to 0.008%, W: 4% to 10%, Nb: 0.005% to 0.25%, and Zr: 0.001% to 0.05%, with the balance being Fe and impurities.

PTL 3 describes a Ni-based alloy material which can ensure corrosion resistance and also can prevent the occurrence of erosion due to high surface hardness in a severe environment which has a temperature of 100° C. to 500° C. and in which erosion and hydrochloric acid or sulfuric acid corrosion occurs. This material contains, by mass %, C: 0.03% or less, Si: 0.01% to 0.5%, Mn: 0.01% to 1.0%, P: 0.03% or less, S: 0.01% or less, Cr: 20% or more and less than 30%, Ni:more than 40% and 50% or less, Cu:more than 2.0% and 5.0% or less, and Mo: 4.0% to 10%, Al: 0.005% to 0.5%, W: 0.1% to 10%, and N:more than 0.10% and 0.35% or less, and a formula, that is, 0.5 Cu+Mo≥6.5· · · (1) is satisfied, with the balance being Fe and impurities.

### CITATION LIST

### Patent Literature

PTL 1: JP2020-196043A
PTL 2: JP2011-214141A
PTL 3: JP2011-063863A

### SUMMARY OF INVENTION

### Technical Problem

As the nickel-based alloy, a high-Cr material having a high Cr content has been developed to improve corrosion resistance and SCC resistance. However, it is known that an ordered phase Ni₂Cr can be formed by an intermetallic compound when exposed to a high-temperature environment for a long time in a case where an atomic concentration ratio of Ni to Cr in the nickel-based alloy is close to 2.

When the nickel-based alloy has an external load or an internal residual stress, uniform dislocations are generally generated in a matrix of the nickel-based alloy. However, when the ordered phase Ni₂Cr is formed, such a single dislocation propagates to a grain boundary with the ordered phase Ni₂Cr. At this time, the dislocation piles up in the grain boundary because the slipping is hindered. As a result, slipping occurs on a new surface, and a so-called non-uniform (discontinuous) dislocation form is obtained.

Therefore, when ordered phase Ni₂Cr is formed in the nickel-based alloy, fracture toughness macroscopically may decrease and SCC sensitivity may be increased due to hardening and embrittlement. When exposed to a high-temperature environment of 250° C. to 350° C. for several tens of years as in an in-reactor environment of a nuclear power plant, the formation of ordered phase Ni₂Cr causes a problem of thermal aging embrittlement.

In PTLs 1 to 3, studies have been made on the SCC resistance, toughness, corrosion resistance, and the like of nickel-based alloys. However, no particular measures are taken against hardening or embrittlement due to thermal aging, which becomes a problem when exposed to a high-temperature environment for a long time.

In view of the above, an object of the invention is to provide a nickel-based alloy that hardly causes hardening and embrittlement due to thermal aging in a high-temperature environment and has excellent aging resistance.

### Solution to Problem

In order to achieve the above object, a nickel-based alloy according to the invention is a nickel-based alloy containing Cr as an essential component, and optionally containing one or more of Fe, Nb, Mn, and Mo as an optional component, with the balance being Ni and unavoidable impurities, in which when [% Ni], [% Cr], [% Fe], [% Nb], [% Mn], and [% Mo] are atomic concentrations of respective elements, an atomic concentration ratio of Ni to Cr [% Ni]/[% Cr] is 1.8 or more and 2.2 or less, and [% Fe]+0.49 [% Nb] 0.63 [% Mn]+0.05 [% Mo]≥14 is satisfied.

+

### Advantageous Effects of Invention

According to the invention, it is possible to provide a nickel-based alloy that hardly causes hardening and embrittlement due to thermal aging in a high-temperature environment and has excellent aging resistance.

### BRIEF DESCRIPTION OF DRAWINGS

FIG. 1 is a bubble chart showing a relationship between an atomic concentration ratio r of Ni to Cr in a nickel-based alloy and an equivalent iron content Eq_{Fe}.

FIG. 2 is a perspective view showing an internal structure of a pressure vessel of a boiling water reactor (BWR).

### DESCRIPTION OF EMBODIMENTS

Hereinafter, a nickel-based alloy (Ni-based alloy) according to an embodiment of the invention and an in-reactor structure of a reactor using the nickel-based alloy will be described with reference to the drawings.

The nickel-based alloy (Ni-based alloy) according to the present embodiment is an alloy containing Ni as a main component, contains Cr as an essential added component, and optionally contains one or more of Fe, Nb, Mn, and Mo as an optional added component, with the balance being Ni and unavoidable impurities. In this Ni-based alloy, content ranges of the essential added components and the optional added components are adjusted in order to prevent hardening and embrittlement due to thermal aging in a high-temperature environment.

In the Ni-based alloy to which Cr is added, when the atomic concentration ratio of Ni to Cr is close to 2 and the Ni-based alloy is exposed to a high-temperature environment for a long time, an ordered phase Ni₂Cr may be formed by an intermetallic compound. When the ordered phase Ni₂Cr is generated, the dislocation piles up in a grain boundary and a non-uniform (discontinuous) form is generated. As a result, age hardening occurs due to unintended thermal aging, and thermal aging embrittlement proceeds.

In contrast, when the content ranges of the essential added components and the optional added components are appropriately limited, hardening and embrittlement due to thermal aging can be prevented. Even when the atomic concentration ratio of Ni to Cr is close to 2, a Ni-based alloy, which hardly causes hardening and embrittlement due to thermal aging and has excellent aging resistance, can be provided.

In general, the ordered phase in the substitutional solid solution is formed by regularly arranging solute atoms in an array of solvent atoms. Phase transformation from the matrix phase to the ordered phase occurs due to diffusion of solute atoms in order to minimize Gibbs free energy. Therefore, the enthalpy of formation of the ordered phase varies depending on the type of the solvent atoms in a crystal structure present before being substituted by the diffusion of the solute atom.

NPL 1 (George A. Young, et al., Physical Metallurgy, Weldability, and In-Service Performance of Nickel-Chromium Filler Metals Used in Nuclear Power Systems, Proceedings of the 15th International Conference on Environmental

Degradation of Materials in Nuclear Power Systems-Water Reactors (2011), The Minerals, Metals, and Materials Society, pp. 2431-2441) describes an enthalpy of formation of a Ni—Cr alloy.

According to NPL 1, an absolute value of the enthalpy of formation of the Ni-based alloy is larger than that of Ni—Cr by +3 KJ/mol in the case of Ni—Cr—Mo, +29 KJ/mol in the case of Ni—Cr—Nb, +37 KJ/mol in the case of Ni—Cr—Mn, and +59 KJ/mol in the case of Ni—Cr—Fe.

However, actual materials contain various solute atoms. When the types or contents of solute atoms are different, the ease of formation of the ordered phase Ni₂Cr is still unknown. The ordered phase Ni₂Cr is hardly formed as an absolute value of the enthalpy of formation is increased. Therefore, in order to prevent the formation of the ordered phase Ni₂Cr in the Ni-based alloy, it is considered to be effective to adjust solute atoms with an increased absolute value of enthalpy of formation to an appropriate content range.

Therefore, in the Ni-based alloy according to the present embodiment, the equivalent iron content Eq_{Fe} for limiting the content range of the added component is set based on Fe which has the largest absolute value of the enthalpy of formation of the ordered phase Ni₂Cr. The equivalent iron content Eq_{Fe} is defined as a ratio of an increment of the enthalpy of formation of the ordered phase Ni₂Cr caused by each added component to an increment of the enthalpy of formation of the ordered phase Ni₂Cr caused by Fe.

### <Equivalent Iron Content Eq_{Fe}>

The Ni-based alloy according to the present embodiment has a chemical composition in which, when [% Fe], [% Nb], [% Mn], and [% Mo] are atomic concentrations (at %) of respective elements, the equivalent satisfies the following formula (1).

$${EQ}_{Fe} [ at \% ] = [ \% Fe ] + 0.49 [ \% Nb ] + 0.63 [ \% Mn ] + 0.05 [ \% Mo ] \geq 14 \qquad ( 1 )$$

If the formula (1) is satisfied, even when the atomic concentration ratio of Ni to Cr is close to a stoichiometric ratio of Ni₂Cr, the ordered phase Ni₂Cr is hardly formed when the Ni-based alloy is exposed to a high-temperature environment for a long time. Hardening or embrittlement due to thermal aging in a high-temperature environment is prevented.

### <Atomic Concentration Ratio r of Ni to Cr>

In the Ni-based alloy according to the present embodiment, when [% Ni] and [% Cr] are atomic concentrations (at %) of respective elements, an atomic concentration ratio r= [% Ni]/[% Cr] of Ni to Cr is 1.8 or more and 2.2 or less.

When the atomic concentration ratio r of Ni to Cr is around 2, the atomic concentration ratio r is close to the stoichiometric ratio of Ni₂Cr. Therefore, the ordered phase Ni₂Cr is likely to be formed when the Ni-based alloy is exposed to a high-temperature environment for a long time. However, when the content range of the added component is limited using the equivalent iron content Eq_{Fe} as an index, the formation of the ordered phase Ni₂Cr can be prevented. Therefore, with the atomic concentration ratio r, the effect of setting the equivalent iron content Eg_{Fe} can be effectively obtained.

The atomic concentration ratio r of Ni to Cr is preferably 1.85 or more, more preferably 1.9 or more, and still more preferably 1.95 or more. The atomic concentration ratio r of Ni to Cr is preferably 2.15 or less, more preferably 2.1 or less, and still more preferably 2.05 or less. With the atomic concentration ratio r, the ordered phase Ni₂Cr is more likely to be formed, and thus the effect of setting the equivalent iron content Eq_{Fe} can be more effectively obtained.

### <Thermal Aging Test and Aging Resistance Evaluation>

Here, a thermal aging test is performed on the Ni-based alloy, and evaluation results of the aging resistance against thermal aging are shown.

As the Ni-based alloy, test samples Nos. 1 to 7 having chemical compositions shown in Table 1 were used. After each of the test samples Nos. 1 to 7 was produced and subjected to a thermal aging test, the presence or absence of aging resistance against thermal aging was evaluated based on Vickers hardness. The thermal aging test was performed at a test temperature of 380° C. for 8264 hours.

As the Vickers hardness, Vickers hardness H₀ before the thermal aging and Vickers hardness H after the thermal aging were measured for each of the test samples Nos. 1 to 7. Then, a difference ΔH=H−H₀ and a standard deviation σ of H₀ were determined. The Vickers hardness was measured at a load of 1 kgf and a holding time of 15 seconds. The number of measurement points was 10 for each test sample, and an average value of measured values of the Vickers hardness was calculated.

The aging resistance against thermal aging was simply determined depending on whether a ratio (ΔH/o) of the difference ΔH to the standard deviation σ of H₀ was more than 1. When ΔH/σ was more than 1, it was determined that age hardening due to thermal aging significantly occurred. When ΔH/σ was 1 or less, it was determined that age hardening due to thermal aging did not significantly occur.

Table 1 shows chemical compositions (mass %) of test samples Nos. 1 to 7. Table 2 shows the chemical compositions (at %), the measurement results of Vickers hardness, and the evaluation results of the presence or absence of aging resistance against thermal aging of the test samples Nos. 1 to 7.

TABLE 1

| | Chemical composition (mass %) | | | | |
|---|---|---|---|---|---|
| No. | Cr | Fe | Nb | Mn | Mo |
| 1 | 31.0 | 0.0 | 0.0 | 0.0 | 0.0 |
| 2 | 22.0 | 1.0 | 2.3 | 0.0 | 0.0 |
| 3 | 27.0 | 1.0 | 2.3 | 0.0 | 0.0 |
| 4 | 27.0 | 1.0 | 0.0 | 0.0 | 0.0 |
| 5 | 22.7 | 5.5 | 1.5 | 1.3 | 0.0 |
| 6 | 25.8 | 16.6 | 1.7 | 2.5 | 0.6 |
| 7 | 28.8 | 7.2 | 1.0 | 1.6 | 0.0 |

TABLE 2

| | | | | | | | | | | | Hardness | |
|---|---|---|---|---|---|---|---|---|---|---|---|---|
| | | | | | | Equivalent | Atomic | | | Hardness | standard | |
| | | | | | | iron | concentration | Hardness H₀ | Hardness H | difference | deviation | |
| | Chemical composition (at. %) | | | | | content | ratio r | (HV) before | (HV) after | ΔH = H − H₀ | σ before | |
| No. | Cr | Fe | Nb | Mn | Mo | Eq_{Fe} (at. %) | [% Ni]/[% Cr] | thermal aging | thermal aging | (HV) | thermal aging | ΔH/σ |
| 1 | 33.7 | 0.0 | 0.0 | 0.0 | 0.0 | 0.0 | 2.0 | 163.4 | 195.0 | 31.6 | 8.1 | 3.9 |
| 2 | 24.3 | 1.0 | 1.4 | 0.0 | 0.0 | 1.7 | 3.0 | 134.5 | 139.6 | 5.1 | 8.1 | 0.6 |
| 3 | 29.7 | 1.0 | 1.4 | 0.0 | 0.0 | 1.7 | 2.3 | 142.3 | 148.5 | 6.2 | 6.1 | 1.0 |
| 4 | 29.4 | 1.0 | 0.0 | 0.0 | 0.0 | 1.0 | 2.4 | 127.0 | 129.4 | 2.4 | 2.9 | 0.8 |
| 5 | 24.9 | 5.7 | 0.9 | 1.3 | 0.0 | 6.9 | 2.7 | 228.5 | 239.0 | 10.5 | 10.4 | 1.0 |
| 6 | 28.0 | 16.8 | 1.0 | 2.6 | 0.3 | 18.9 | 1.8 | 240.4 | 252.2 | 11.8 | 15.7 | 0.7 |
| 7 | 31.7 | 9.8 | 0.0 | 0.3 | 0.0 | 10.0 | 1.8 | 171.2 | 181.0 | 9.8 | 5.9 | 1.7 |

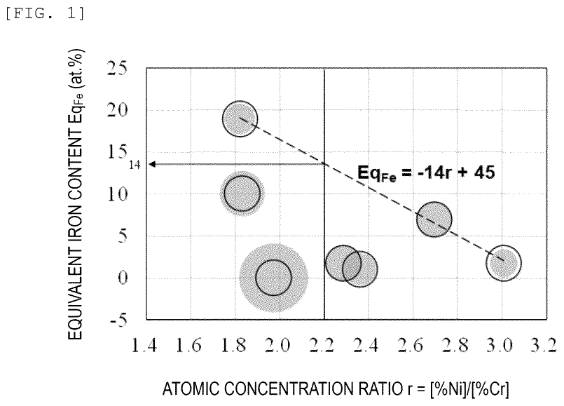

FIG. 1 is a bubble chart showing a relationship between the atomic concentration ratio r of Ni to Cr in the nickel-based alloy and the equivalent iron content Eq_{Fe}. In FIG. 1, a horizontal axis represents an atomic concentration ratio r of Ni to Cr, which is equal to [% Ni]/[% Cr], and a vertical axis represents the equivalent iron content Eq_{Fe} [at %]. Bubbles indicated by “•” show results of the respective test samples Nos. 1 to 7. An area of the bubble indicated by “•” represents the magnitude of ΔH/o, and an area of a bubble indicated by “o” represents Δ/σ=1.

As shown in FIG. 1, when the atomic concentration ratio r was larger than 2.2, ΔH/σ<1, and it was determined that age hardening due to thermal aging did not significantly occur. On the other hand, when the atomic concentration ratio r was 2.2 or less, there was a case where ΔH/σ>1, and it was determined that age hardening due to thermal aging may occur. In the range in which the atomic concentration ratio r was 2.2 or less, the smaller the equivalent iron content Eq_{Fe} is, the larger the ΔH/σ is, and the tendency of thermal aging to progress was observed.

Among the results of the test samples Nos. 1 to 7, a limit value of the equivalent iron content Eq_{Fe} was determined using the result satisfying the relationship of ΔH/σ≤1 and having a large equivalent iron content Eq_{Fe}. The limit value of the equivalent iron content Eq_{Fe} was determined by linear approximation in the range of 1.8≤R≤3.0. As an approximate line indicating the limit value of the equivalent iron content Eq_{Fe}, the following equation (2) was obtained.

$${Eq}_{Fe} = - 14 R + 45 \qquad ( 2 )$$

According to the formula (2), in order to prevent hardening or embrittlement due to thermal aging, it is necessary that the equivalent iron content Eq_{Fe} is 14 at % or more in the range of 1.8≤R≤2.2. With the chemical composition satisfying the formula (1), even when the atomic concentration ratio r of Ni to Cr is close to the stoichiometric ratio of Ni₂Cr, the ordered phase Ni₂Cr is hardly formed, and it can be said that hardening or embrittlement due to thermal aging is prevented in a high-temperature environment.

The rate of change in hardness due to thermal aging can be mutually converted for each condition of the temperature and time of thermal aging by using the Kolomogorov-Johnson-Mehl-Avrami (KJMA) equation. The KJMA equation is generally known as an equation indicating the time dependence of the phase transformation completion volume.

NPL 2 (George A. Young and Daniel R. Eno, Long Range Ordering in Model Ni—Cr—X Alloys, Fontevraud 8-Contribution of Materials Investigations and Operating Experience to LWRs'Safety, Performance and Reliability, France, Avignon (2014), September 14) describes the following formula (3) based on KJMA equation.

$$f = ( H - {H}_{0} ) / ( {H}_{m ax} - {H}_{0} ) = 1 - exp ( - {( kt )}^{n} ) \qquad ( 3 )$$

[Here, in the formula (3), f represents a change rate function, H₀ represents Vickers hardness before the thermal aging, H represents Vickers hardness at the moment after the thermal aging, Hₘₐₓ represents the maximum Vickers hardness after the thermal aging, t represents aging time, k represents a speed coefficient, and n represents an avrami exponent.]

The speed coefficient k in the formula (3) can be assumed to be an Arrhenius equation, and can be expressed by the following formula (4).

$$k = {k}_{0} \times exp ( - Q / R T ) \qquad ( 4 )$$

[Here, in the formula (4), k₀ represents a frequency factor, Q represents activation energy, R represents a gas constant, and T represents an absolute temperature.]

In the case of phase transformation for forming the ordered phase Ni₂Cr, the Avrami exponent n can be set to n=0.65, and the frequency factor k₀ can be set to k₀=3.5×10⁷ [h⁻¹]. The gas constant R is 8.314 J/(mol•K). As the activation energy Q, Q=147 KJ/mol can be used as the apparent activation energy of the ordered phase Ni₂Cr.

Using formulas (3) and (4), as described above, when the test temperature T of the thermal aging test is set to T=653 K (380° C.) and the test time t is set to t=8264 h, it can be seen that the change rate function f is equivalent to the case where T=561 K (288° C.) and t=700800 h (80 years). The environment at 288° C. corresponds to a severe environment such as a portion with which high-temperature and high-pressure reactor water comes into contact in a BWR or the like.

Therefore, it can be said that when the formula (1) is satisfied, in a severe environment at a high temperature and a high pressure, hardening or embrittlement due to thermal aging can be prevented for a long time such as about 80 years. Even when the atomic concentration ratio r of Ni to Cr is close to the stoichiometric ratio of the ordered phase Ni₂Cr, a Ni-based alloy having excellent aging resistance against thermal aging can be provided.

### <Chemical Composition>

Here, a chemical composition of the Ni-based alloy according to the present embodiment will be described more specifically. The Ni-based alloy may contain C, Si, W, Co, Ti, Al, Cu, V, B, Zr, or the like as an optional added component in addition to one or more of Fe, Nb, Mn, and Mo. In the following description, “%” as a non-limited unit means “mass %”.

### (Cr: 23% to 28%)

Cr is effective in improving corrosion resistance, SCC resistance, and high-temperature strength. The content of Cr needs to be 16% or more from the viewpoint of improving corrosion resistance. However, the ordered phase Ni₂Cr may be generated at about 23% or more. On the other hand, when the content of Cr is too large, toughness, workability, and weldability decreases, and high-temperature cracking sensitivity is increased. In addition, the effect of improving the corrosion resistance is reduced when the content of Cr exceeds 28%. Therefore, the content of Cr is preferably 23% or more and 28% or less. The content of Cr is more preferably 26% or more and 28% or less from the viewpoint of improving the high-temperature strength.

### (Fe: 8% or More)

Fe is effective in increasing the enthalpy of formation of the ordered phase Ni₂Cr. In addition, Fe contributes to improvement in mechanical properties and is lower in cost than Ni. On the other hand, when the content of Fe is too large, the corrosion resistance decreases. The content of Fe is preferably 8% or more and 30% or less based on the formula (1) and a relationship with contents of other elements.

### (Nb: 1% to 9%)

Nb is effective in increasing the enthalpy of formation of the ordered phase Ni₂Cr. In addition, Nb preferentially binds to C to prevent precipitation of a Cr carbide, and therefore, Nb contributes to improvement in corrosion resistance and SCC resistance. Nb also contributes to improvement in high-temperature strength and toughness. The content of Nb needs to be at least 1% or more in order to prevent the formation of a Cr carbide. The content of Nb is preferably 1% or more and 9% or less from the viewpoint of improving corrosion resistance and SCC resistance or based on the relationship with the contents of other elements. The content of Nb is preferably 2% or more, and more preferably 3% or more.

(Mn: 5% or less)

Mn is effective in increasing the enthalpy of formation of the ordered phase Ni₂Cr. Mn is added as a deoxidizing agent. On the other hand, when the content of Mn is too large, inclusions are formed, and the grain boundary corrosion sensitivity increases. Since Mn has a smaller effect of increasing the enthalpy of formation than Fe, Mn may or may not be positively added. The content of Mn is preferably 5% or less, more preferably 3% or less, and still more preferably 1% or less from the viewpoint of the relationship with the contents of other elements. The content of Mn is preferably 0.01% or more, and more preferably 0.1% or more when Mn is positively added.

(Mo: 3% or less)

Mo is effective in increasing the enthalpy of formation of the ordered phase Ni₂Cr. Mo contributes to improvement in corrosion resistance and high-temperature strength. On the other hand, when the content of Mo is too large, workability and weldability decrease. Since Mo has a smaller effect of increasing the enthalpy of formation than Fe or the like, Mo may or may not be positively added. The content of Mo is preferably 3% or less, more preferably 2% or less, and still more preferably 1% or less from the viewpoint of the relationship with the contents of other elements. The content of Mo is preferably 0.01% or more, and more preferably 0.1% or more when Mo is positively added.

(C: 0.05% or less)

C contributes to improvement in mechanical properties such as high-temperature strength and grain boundary strength. On the other hand, when the content of C is too large, a carbide is generated, and corrosion resistance and SCC resistance decrease. C may or may not be positively added. The content of C is preferably 0.05% or less, more preferably 0.04% or less, and still more preferably 0.03% or less from the viewpoint of ensuring corrosion resistance and SCC resistance. The content of C is preferably 0.01% or more when C is positively added.

(Si: 0.5% or less)

Si is added as a deoxidizing agent and contributes to improvement in oxidation resistance and molten metal fluidity. On the other hand, when the content of Si is too large, ductility and corrosion resistance decrease. Si may or may not be positively added. The content of Si is preferably 0.5% or less, more preferably 0.4% or less, and still more preferably 0.3% or less from the viewpoint of ensuring ductility and corrosion resistance. The content of Si is preferably 0.01% or more, and more preferably 0.05% or more when Si is positively added.

(W: 5% or less)

W contributes to improvement in mechanical properties such as high-temperature strength. On the other hand, when the content of W is too large, workability and weldability decrease. W may or may not be positively added. The content of W is preferably 0.01% or more and more preferably 0.1% or more when W is positively added. The content of W is preferably 5% or less, more preferably 3% or less, and still more preferably 1% or less from the viewpoint of workability and weldability.

(Co: 3% or less)

Co contributes to ensuring mechanical properties such as high-temperature strength and corrosion resistance. On the other hand, when the content of Co is too large, the workability and the cost efficiency decrease, and there is also a problem of radioactive contamination. Co may or may not be positively added. The content of Co is preferably 0.01% or more, and more preferably 0.1% or more when Co is positively added. The content of Co is preferably 3% or less, more preferably 2% or less, and still more preferably 1% or less from the viewpoint of workability, cost efficiency, radioactive contamination, and the like.

(Ti: 1% or less)

Ti preferentially binds to C to prevent precipitation of a Cr carbide, and therefore, Ti contributes to improvement in corrosion resistance and SCC resistance. Ti also contributes to improvement in high-temperature strength and creep strength. Ti may or may not be positively added. The content of Ti is preferably 0.01% or more, and more preferably 0.1% or more when Ti is positively added. The content of Ti is preferably 1% or less, and more preferably 0.5% or less, from the viewpoint of workability and the like.

(Al: 0.5% or less)

Al is added as a deoxidizing agent and contributes to improvement in high-temperature strength and creep strength. On the other hand, when the content of Al is too large, workability and weldability decrease. Al may or may not be positively added. The content of sol. Al is preferably 0.01% or more, and more preferably 0.1% or more when positively added. The content of sol. Al is preferably 0.5% or less, more preferably 0.4% or less, and still more preferably 0.3% or less from the viewpoint of workability and weldability.

(Cu: 5% or less)

Cu contributes to improvement in corrosion resistance and strength. On the other hand, when the content of Cu is too large, workability and weldability decrease. Cu may or may not be positively added. The content of Cu is preferably 0.01% or more, and more preferably 0.1% or more from the viewpoint of ensuring corrosion resistance and strength. The content of Cu is preferably 5% or less, more preferably 3% or less, and still more preferably 1% or less from the viewpoint of workability and weldability.

(V: 1% or less)

V contributes to improvement in mechanical properties such as strength. On the other hand, when the content of V is too large, the workability decreases. V may or may not be positively added. The content of V is preferably 0.01% or more, and more preferably 0.1% or more from the viewpoint of ensuring strength. The content of V is preferably 1% or less, more preferably 0.8% or less, and still more preferably 0.6% or less from the viewpoint of workability and the like.

(B: 0.05% or less)

B contributes to improvement in mechanical properties such as grain boundary strength. B may or may not be positively added. On the other hand, when the content of B is too large, weldability decreases. The content of B is preferably 0.001% or more, and more preferably 0.01% or more from the viewpoint of improving the grain boundary strength. The content of B is preferably 0.05% or less and more preferably 0.03% or less from the viewpoint of weldability and the like.

(Zr: 0.1% or less)

Zr contributes to improvement in mechanical properties such as grain boundary strength. Zr may or may not be positively added. On the other hand, when the content of Zr is too large, weldability decreases. The content of Zr r is preferably 0.01% or more, and more preferably 0.1% or more from the viewpoint of improving grain boundary strength. The content of Zr is preferably 0.1% or less, more preferably 0.08% or less, and still more preferably 0.06% or less from the viewpoint of weldability and the like.

### (Unavoidable Impurities)

Examples of the unavoidable impurities include impurities mixed in a raw material and impurities mixed in a production process. Examples thereof include P, S, O, Sn, and Pb. P and S cause corrosion resistance, workability, and weldability to decrease. The content of P is preferably 0.03% or less, more preferably 0.02% or less, and still more preferably 0.01% or less. The content of S is preferably 0.02% or less, more preferably 0.015% or less, and still more preferably 0.01% or less. The total content of other elements is 0.05% or less and preferably 0.5% or less.

### <Production Method>

The Ni-based alloy according to the present embodiment can be produced by an appropriate method. For example, a base metal or scrap as a raw material containing Ni, Cr, Fe, or the like is adjusted to an appropriate chemical composition and then melted in an electric furnace or the like to form a molten metal. Then, a decarburization treatment is performed by an argon oxygen decarburization (AOD) method or a vacuum oxygen decarburization (VOD) method, and after performing a decarburization treatment, a reduction treatment, and a desulfurization treatment, an intermediate material such as a slab, a billet, or a bloom is cast. The intermediate material can be subjected to solution treatment or processing.

The Ni-based alloy can be subjected to appropriate hot or cold forging and rolling depending on the use of the Ni-based alloy or the like. In addition, the welding material of the Ni-based alloy can be produced by extending a billet or the like into a wire shape. The welding material of the Ni-based alloy can be used for appropriate welding such as TIG welding, MIG welding, shielded metal arc welding, electron beam welding, and laser welding.

### <Use>

The Ni-based alloy according to the present embodiment is preferably used in a high-temperature environment where the Ni-based alloy is exposed to a high temperature for a long time. Examples of the use of the Ni-based alloy include materials constituting a nuclear power plant, a thermal power plant, a chemical plant, a petroleum excavation plant, a natural gas excavation plant, a gas engine, a gas turbine, and the like. The Ni-based alloy can be used as a structural member in such equipment, a device such as a pipe, or a material for a weld portion.

The Ni-based alloy according to the present embodiment is particularly preferably used in a high-temperature environment of 250° C. or higher and 350° C. or lower, and more preferably used in an environment in which the Ni-based alloy comes into contact with high-temperature water having such a temperature. For example, it can be preferably used as a material for an in-reactor structure of a boiling water reactor (BWR) or a pressurized water reactor (PWR) or a material for an in-reactor device. Even in such a severe environment, hardening or embrittlement due to thermal aging for several tens of years can be prevented, and therefore, deterioration or damage over time can be prevented.

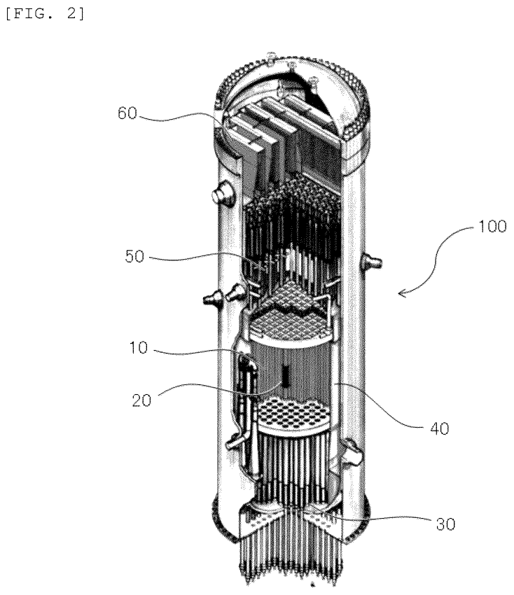

FIG. 2 is a perspective view showing an internal structure of a pressure vessel of the boiling water reactor (BWR). In FIG. 2, an internal structure is illustrated by cutting out a part of the pressure vessel.

As shown in FIG. 2, fuel assemblies 10, control rods 20, a control rod drive system 30, a core shroud 40, a steam separator 50, a steam dryer 60, and the like are provided inside a pressure vessel 100 of the boiling water reactor (BWR).

In the core of the pressure vessel 100, a plurality of fuel assemblies 10 are loaded in a lattice array. The core is provided such that the control rods 20 for controlling the nuclear reaction of the fuel assemblies 10 can be inserted and removed. The control rod drive system 30 is coupled to the control rod 20 at a bottom portion of the pressure vessel 100. The insertion and removal of the control rod 20 are driven by the control rod drive system 30.

The core of the pressure vessel 100 is surrounded by the core shroud 40 having a cylindrical shape. An upper grid plate that defines an upper end of the core and a core support plate that defines a lower end of the core are attached to the inside of the core shroud 40. An upper portion of the core shroud 40 is covered with a shroud head.

The core shroud 40 is supported by and fixed onto a shroud support. The shroud support is formed by a cylindrical shroud support cylinder that supports the core shroud 40, a plurality of leg-shaped shroud support legs that support the cylinder from below, a circular ring-shaped shroud support plate that protrudes from a side of the cylinder and is supported from an inner circumferential surface of the pressure vessel 100, or the like.

The steam separator 50 is disposed above the shroud head. The steam dryer 60 is disposed above the steam separator 50. The cooling water flowing into the pressure vessel 100 is supplied to the core loaded with the fuel assemblies 10 by a jet pump provided at the bottom portion of the pressure vessel 100. The cooling water is heated by the nuclear reaction of the fuel assemblies 10 to form a gas-liquid two-phase flow.

The steam separator 50 separates the gas-liquid two-phase flow generated by heating into steam and water. The water falls through a downcomer around the core shroud 40 and becomes cooling water again. On the other hand, the steam flows into the upper steam dryer 60. The steam dryer 60 removes moisture contained in the steam. The steam from which the moisture has been removed is supplied to a turbine and used for power generation. The steam used for power generation is converted back into cooling water by a condenser, and then supplied to the pressure vessel 100 again.

The structural member constituting the in-reactor structure such as the core shroud 40, the steam separator 50, and the steam dryer 60, the in-reactor device such as a pipe of a water supply system, a sparger, and a nozzle, the weld portion joining them, and the like serve as a liquid contact portion that comes into contact with high-temperature water of 250° C. or higher and 350° C. or lower during the operation of the nuclear reactor. In general, a covering tube of the fuel assembly 10, the core shroud 40, the steam separator 50, the steam dryer 60, and the like are formed of stainless steel.

The Ni-based alloy according to the present embodiment can be used as a material for an in-reactor structure of a nuclear power plant and an in-reactor device of a nuclear power plant, which come into contact with reactor water of 250° C. or higher and 350° C. or lower. The Ni-based alloy according to the present embodiment can be joined to an in-reactor structure formed of stainless steel which is different from the Ni-based alloy.

Specific examples of the portion to which the Ni-based alloy according to the present embodiment is applied include a shroud support, a pipe member such as a neutron instrumentation detector tube, a control rod guide tube, and an inspection instrument guide tube, a nozzle member such as a nozzle portion of a water supply inlet and a nozzle portion of a recirculation water inlet, and a welding material of a weld portion of a shroud. Examples of the weld portion include support portions including a shroud support cylinder, a shroud support leg, a shroud support plate, and the like, and a cladding part of a lower mirror portion of a pressure vessel.

With the Ni-based alloy according to the present embodiment described above, the content range of the added components is appropriately adjusted according to the condition of the equivalent iron content Eq_{Fe}. Therefore, even when the atomic concentration ratio r of Ni to Cr is close to the stoichiometric ratio of the ordered phase Ni₂Cr, the ordered phase Ni₂Cr is hardly formed when the Ni-based alloy is exposed to a high-temperature environment for a long time. The hardening or embrittlement due to thermal aging is prevented in a high-temperature environment, and therefore, a Ni-based alloy having excellent aging resistance against thermal aging can be obtained. Regarding materials used in a severe environment, corrosion resistance, high-temperature strength, creep strength, and the like can be ensured, and at the same time, deterioration or damage over time such as thermal aging embrittlement and SCC can be prevented.

Although the embodiments of the invention have been described above, the invention is not limited to the above-described embodiments, and various modifications can be made without departing from the gist of the invention. For example, the invention is not necessarily limited to the one including all the configurations included in the above-described embodiment. A part of a configuration of an embodiment may be replaced with another configuration, a part of the configuration of the embodiment may be added to another configuration, or a part of the configuration of the embodiment may be omitted.

### EXAMPLES

The invention will be specifically described below with reference to Examples, but the technical scope of the invention is not limited thereto.

A Ni-based alloy satisfying the condition of the equivalent iron content Eq_{Fe} represented by the formula (1) was produced, and the aging resistance against thermal aging was evaluated.

As the Ni-based alloy, an ingot of a quaternary model alloy of Ni—Cr—Fe—Nb was produced. A lump material of each element having a particle diameter of about 10 mm was melted at a high frequency by induction heating using a high-frequency current in an alumina crucible under an argon atmosphere at 1 atm. The obtained molten metal was cast into a copper mold to form a 300 g prismatic ingot.

The produced ingot was subjected to inductively coupled plasma (ICP) emission spectroscopic analysis to analyze the chemical composition of the Ni-based alloy. In addition, the produced ingot was subjected to a thermal aging test, and the presence or absence of age hardening was evaluated based on Vickers hardness. The thermal aging test was performed at a test temperature of 380° C. for 8264 hours.

As the Vickers hardness, the Vickers hardness H₀ before the thermal aging and the Vickers hardness H after thermal aging were measured. Then, a difference ΔH=H−H₀ and a standard deviation σ of H₀ were determined. The Vickers hardness was measured at a load of 1 kgf and a holding time of 15 seconds. The number of measurement points was 10 for each test sample, and an average value of measured values of the Vickers hardness was calculated.

Table 3 shows the chemical compositions (mass %, at %) of the test samples and the evaluation results of the presence or absence of aging resistance against thermal aging.

TABLE 3

| | | | | | | Atomic | Equivalent | |
|---|---|---|---|---|---|---|---|---|
| | | | | | | concentra- | iron | |
| | | | | | | tion ratio | content | |
| | Chemical composition | | | | | r [% Ni]/ | Eq_{Fe} | |
| | Cr | Fe | Nb | Mn | Mo | [% Cr] | (at. %) | ΔH/σ |
| Mass con- | 24.3 | 13.0 | 2.7 | 0.0 | 0.0 | 2.19 | 14.1 | 0.6 |
| centration | | | | | | | | |
| (mass %) | | | | | | | | |
| Atomic con- | 26.7 | 13.3 | 1.7 | 0.0 | 0.0 | | | |
| centration | | | | | | | | |
| (at. %) | | | | | | | | |

As shown in Table 3, the atomic concentration ratio r of Ni to Cr was 2.19. The equivalent iron content Eq_{Fe} was 14.1 at %. A ratio (ΔH/σ) of the difference ΔH to the standard deviation σ of the Vickers hardness H₀ before thermal aging was 60%. It was found that even when Cr is somewhat insufficient with respect to the stoichiometric ratio of Ni₂Cr, age hardening due to thermal aging does not significantly occur.

### REFERENCE SIGNS LIST

10: fuel assembly
20: control rod
30: control rod drive system
40: core shroud
50: steam separator
60: steam dryer
100: pressure vessel

1. A nickel-based alloy comprising Cr as an essential component, and optionally comprising one or more of Fe, Nb, Mn, and Mo as an optional component, with the balance being Ni and unavoidable impurities, wherein
when [% Ni], [% Cr], [% Fe], [% Nb], [% Mn], and [% Mo] are atomic concentrations of respective elements,
an atomic concentration ratio of Ni to Cr [% Ni]/[% Cr] is 1.8 or more and 2.2 or less, and [% Fe]+0.49 [% Nb]+0.63 [% Mn]+0.05 [% Mo]≥14 is satisfied.

2. The nickel-based alloy according to claim 1, wherein
Cr is 23 mass % or more and 28 mass % or less.

3. The nickel-based alloy according to claim 2, wherein
Fe is 8 mass % or more.

4. The nickel-based alloy according to claim 3, wherein
Nb is 1 mass % or more and 9 mass % or less, Mn is 0.01 mass % or more and 5 mass % or less, or Mo is 0.01 mass % or more and 3 mass % or less.

5. The nickel-based alloy according to claim 4, further comprising:
C: 0.05 mass % or less;
Si: 0.5 mass % or less;
P: 0.03 mass % or less; and
S: 0.02 mass % or less.

6. The nickel-based alloy according to claim 1, which is to be used in a high-temperature environment of 250° C. or higher and 350° C. or lower.

7. The nickel-based alloy according to claim 1, which is to be used as a material for an in-reactor structure or an in-reactor device of a nuclear power plant.

8. The nickel-based alloy according to claim 2, which is to be used in a high-temperature environment of 250° C. or higher and 350° C. or lower.

9. The nickel-based alloy according to claim 3, which is to be used in a high-temperature environment of 250° C. or higher and 350° C. or lower.

10. The nickel-based alloy according to claim 4, which is to be used in a high-temperature environment of 250° C. or higher and 350° C. or lower.

11. The nickel-based alloy according to claim 5, which is to be used in a high-temperature environment of 250° C. or higher and 350° C. or lower.

12. The nickel-based alloy according to claim 2, which is to be used as a material for an in-reactor structure or an in-reactor device of a nuclear power plant.

13. The nickel-based alloy according to claim 3, which is to be used as a material for an in-reactor structure or an in-reactor device of a nuclear power plant.

14. The nickel-based alloy according to claim 4, which is to be used as a material for an in-reactor structure or an in-reactor device of a nuclear power plant.

15. The nickel-based alloy according to claim 5, which is to be used as a material for an in-reactor structure or an in-reactor device of a nuclear power plant.
